(19) United States
(12) Patent Application Publication
(10) Pub. No.: US 2013/0232089 A1
(43) Pub. Date: Sep. 5, 2013

(54) Method and System for Adaptive Appointment Scheduling

(71) Applicants: Amrinder Arora, Centreville, VA (US); Nipun Arora, Delhi (IN); Nitin Sehra, Delhi (IN); Daniel Reiss, Ashburn, VA (US)

(72) Inventors: Amrinder Arora, Centreville, VA (US); Nipun Arora, Delhi (IN); Nitin Sehra, Delhi (IN); Daniel Reiss, Ashburn, VA (US)

(21) Appl. No.: 13/597,792

(22) Filed: Aug. 29, 2012

Related U.S. Application Data
(63) Continuation-in-part of application No. 13/411,578, filed on Mar. 4, 2012.

(51) Int. Cl. G06Q 10/08

(52) U.S. Cl. 705/333

(57) ABSTRACT

The solution to the static appointment problem is adaptive appointment scheduling, where the system can estimate the arrival time of a truck with the given information like ETA (Estimated Time of arrival) of truck and truck route traffic information, and it can adjust the appointments accordingly, to manage terminal resources efficiently and minimize the congestion. In addition, we present a new method and system to calculate and present options when planning to move or transfer from point A to point B. We are introducing a new concept where user have more defining measurable factors in route selection, with option to further optimize the result based on user preference. Other examples and methods are also given.

### RELATED APPLICATION

This application is a continuation-in-part (CIP) of another co-pending U.S. application Ser. No. 13/411,578, titled “Method and System for Calculating and Presenting Options for Planning Transportation”, filed 4 Mar. 2012, with the same assignee, NTELX Inc. The teachings and all specification of Ser. No. 13/411,578 are incorporated herein by reference.

### BACKGROUND

The port terminals create appointment slots with the specifications like time, duration and capacity of the slot. The trucking companies check the available slots and take an appointment as per the need basis. The booking for the slot is closed after specific interval of time. Further, the terminal operator manages the terminal resources according to the appointments taken.

If the truck is not able to arrive on schedule, as per the appointment time, due to some inevitable reasons like congestion, breakdown, etc., the truck arrives at a later time, which is an appointment time for some other truck. This causes congestion on the port, or waiting time, even for on-time arrived trucks, and thus, results in the mismanagement of the terminal resources.

In addition, we present a new way to calculate and present routing options when you are travelling from point A to point B, or moving objects between 2 locations. The main problem that the travelers currently face when selecting trip options is that there is no holistic way to evaluate all aspects of an option. We elucidate this problem using some examples. For example, it is possible that the cheapest trip option takes about 3 times as long as an option that only costs a small fraction more. Similarly, the shortest possible option may cost 10 times as much as another option that takes fractionally longer time. Also, it is possible that an option that is shortest in time, as well as cheapest, uses an airline that has very low customer satisfaction. As another example, when shipping a container between two cities, it is possible that the cheapest and the fastest service is provided by a trucking company that has the largest (worst) environmental impact. The user generally would like a way to consolidate all options of a transportation option (whether for passenger travel or for freight transportation), in order to make a choice that performs reasonably well on multiple aspects.

### SUMMARY

The solution to the static appointment problem is adaptive appointment scheduling, where the system can estimate the arrival time of a truck with the given information like ETA (Estimated Time of arrival) of truck and truck route traffic information, and it can adjust the appointments accordingly, to manage terminal resources efficiently and minimize the congestion.

We will have the following features:
The route traffic data, truck location and other information help in estimation of arrival time information.
The appointment to arrival time mapping helps user to visualize the individual truck arrival status at any time.
The appointment daily summary helps user to visualize appointment summary, e.g. count of trucks which are early/on-time/late.
Based on status and summary information, system will adjust appointments, or user can adjust any appointment manually.
While adjusting appointments by the system, different policies/rules are applied.

In addition, we present a new method and system to calculate and present options when planning a trip from point A to point B. We are introducing a new concept where user have more defining measurable factors in route selection, with option to further optimize the result based on user preference. The method can be used for passenger trip planning (for example, when booking a flight) and for freight trip planning (for example, when shipping an object).

The method consists of 4 phases. First, we consider all attributes of each option. Second, we remove all options for which some attributes do not perform within lower and upper bounds. Third, we run a multi-criteria optimization to order the options. Finally, the system presents the options to the user. The user can then select any of the options. If needed, the user can also modify the configuration options and restart the process. See FIG. 1 for the process.

### BRIEF DESCRIPTION OF THE DRAWINGS

FIG. 1 shows an embodiment of the process.

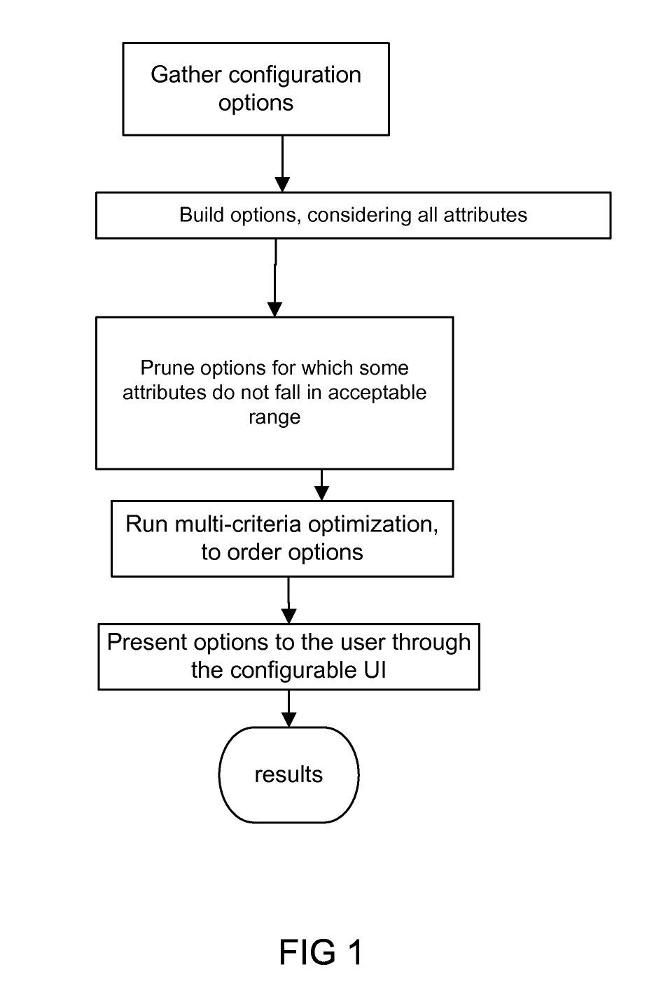

FIG. 2 shows an embodiment of an interface.

FIG. 3 shows an embodiment of the system.

FIG. 4 shows an embodiment of the system.

FIG. 5 shows an embodiment of the system.

FIG. 6 shows an embodiment of the system.

FIG. 7 shows an embodiment of an interface.

FIG. 8 shows an embodiment of an interface.

FIG. 9 shows an embodiment of an interface.

FIG. 10 shows an embodiment of an interface.

FIG. 11 shows an embodiment of an interface.

FIG. 12 shows an embodiment of the system.

FIG. 13 shows an embodiment of the method.

FIG. 14 shows a flow chart of a method of an embodiment of the invention.

### DETAILED DESCRIPTION OF THE EMBODIMENTS

Here is one of the embodiments of the invention:

Arrival Information:

The appointment system is provided for the estimated time of arrival (ETA) of the truck, which helps the system to adjust the appointment dynamically. ETA is expected to be updated with the help of real-time information like GPS, RFID, phone calls, etc.

Appointments Visualizer: Criss-Cross Visualization:

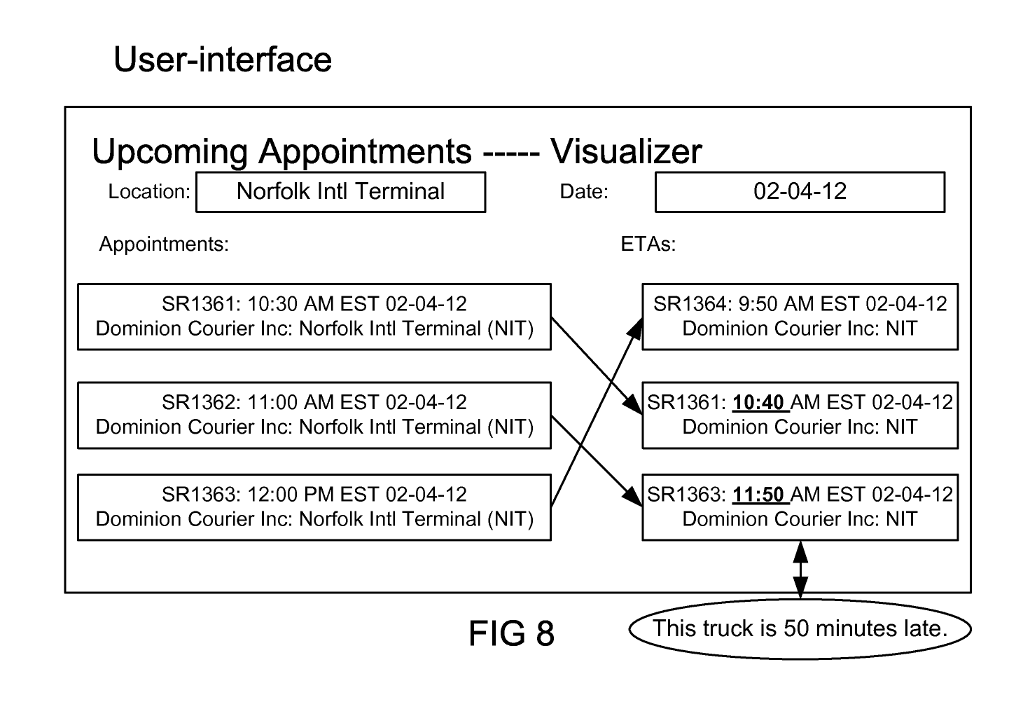

The UI (user interface) shows the mapping of appointment of a truck with its ETA. The interface allows user to filter the entries according to terminal location and appointment date. FIG. 8 shows an example of such system. Note that 2 of the items in the schedule for times indicated are highlighted in FIG. 8, for possible changes, in one embodiment.

Appointments Summary:

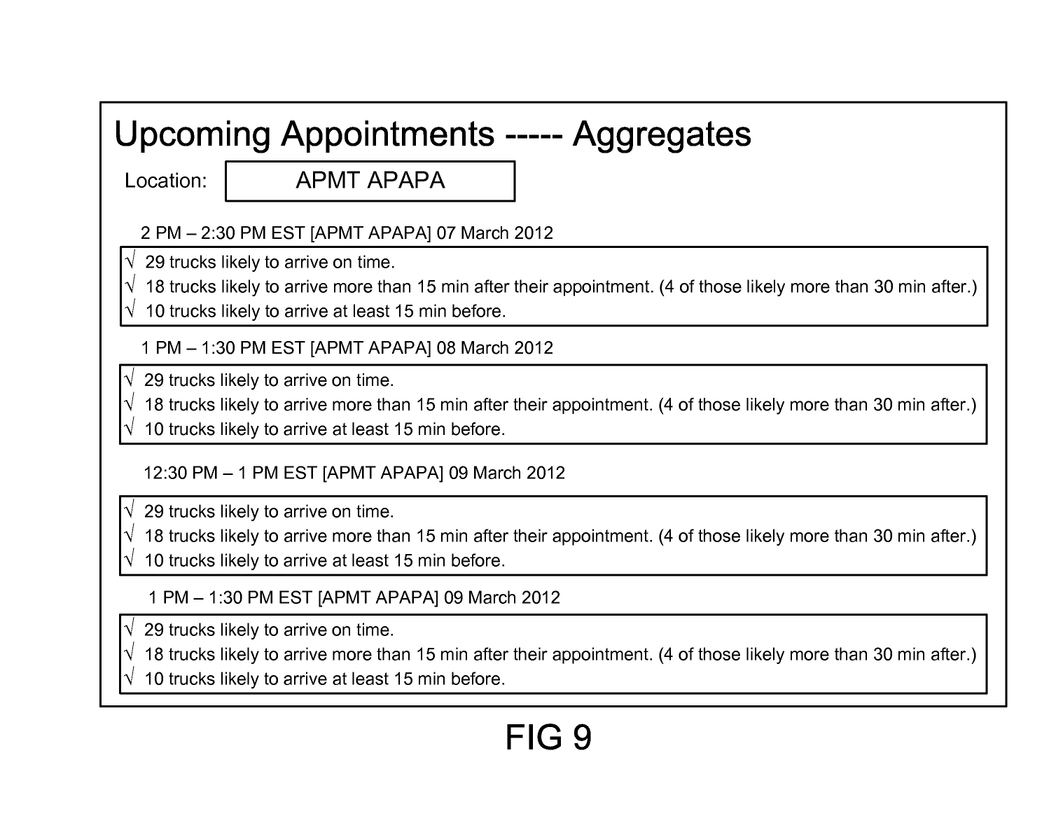

The UI shows a summary of truck arrivals at a specific time slot for a terminal location. The interface allows user to filter the entries according to terminal location. FIG. 9 shows an example of such system.

Appointment adjustment screen:

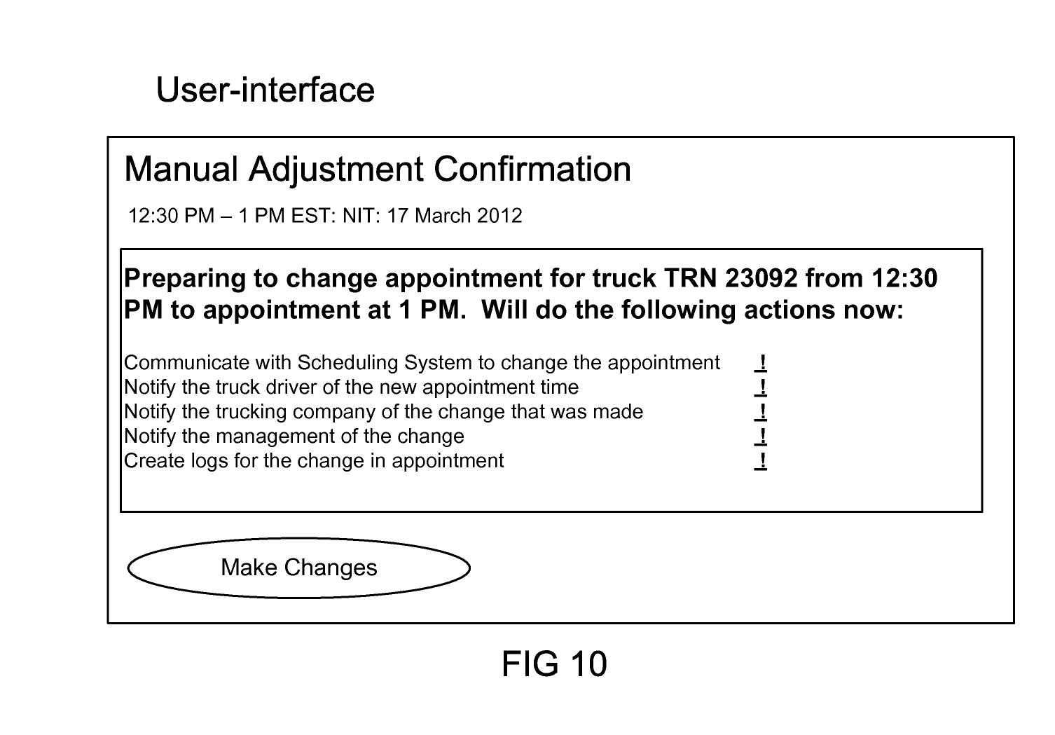

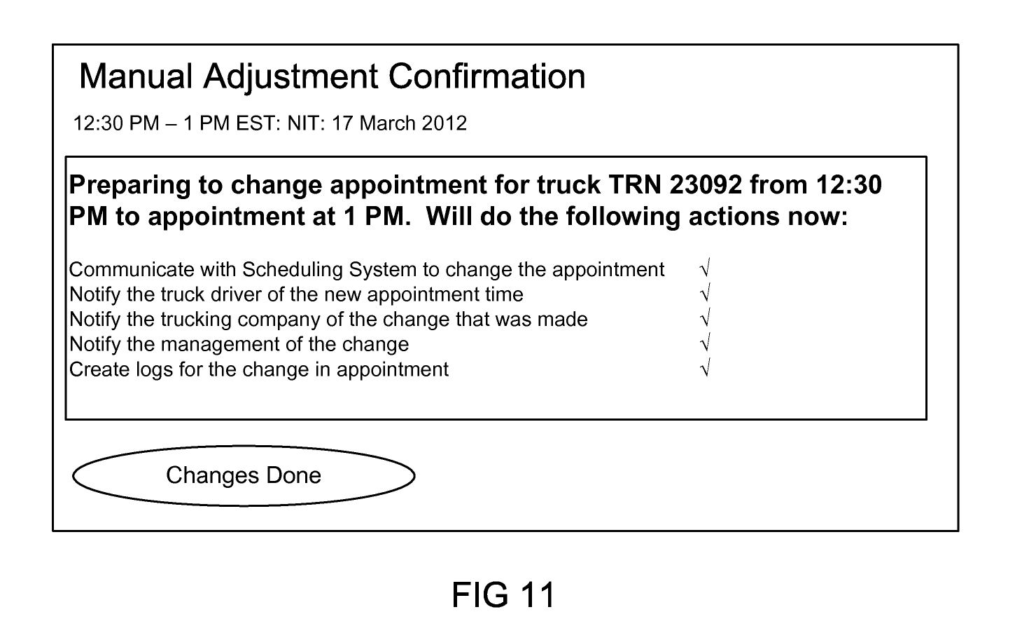

Besides the automated appointment adjustments, the system also provides the option to adjust appointments manually. The option for manual adjustment is provided on appointments home page, corresponding to each appointment, and clicking on it takes the user to a new page where the user is notified about all actions that will be executed as the result of manual adjustment. FIG. 10 and FIG. 11 show examples of such system.

Many policies can be supported:

We provide the system with different policies, and adaptive scheduling/adjustments are automatically executed according to the selected policy. The different policies supported by our system are, as an example:
Maximize the number of turns
Minimize the waiting time
Minimize appointment changes
Custom

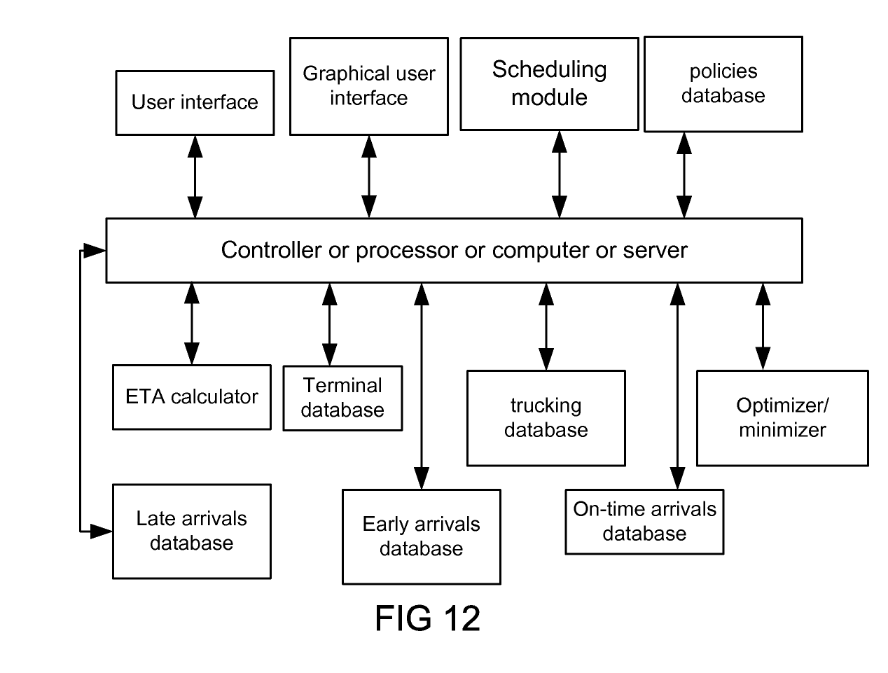

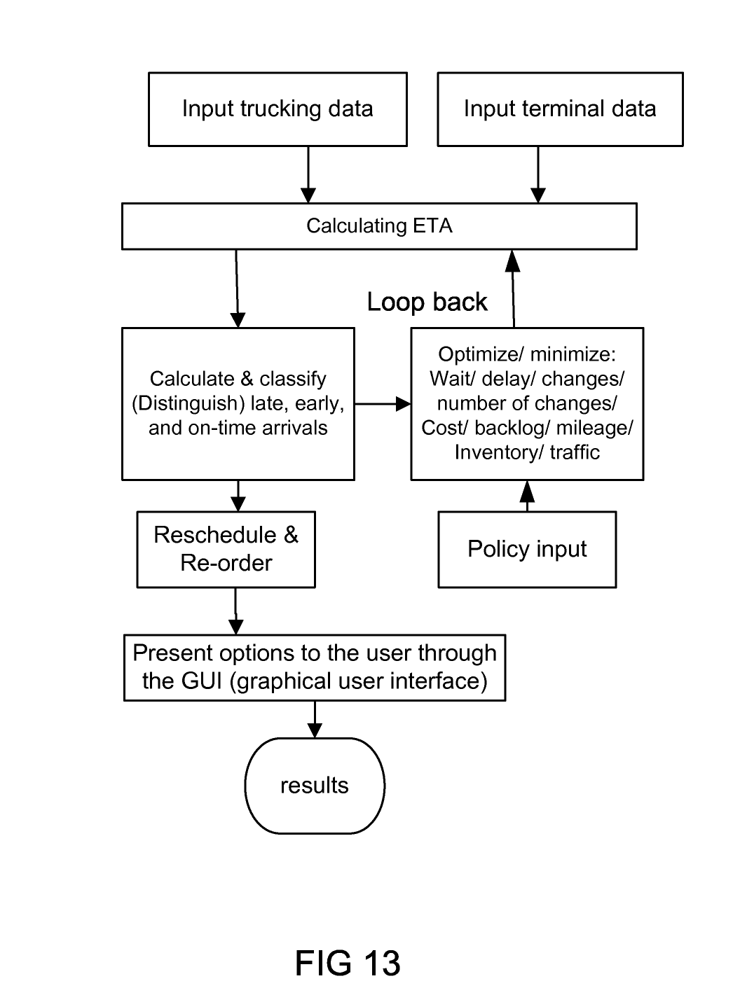

FIG. 12 shows an example of such system. FIG. 13 shows an example of such method.

Now, let's look at another embodiment:

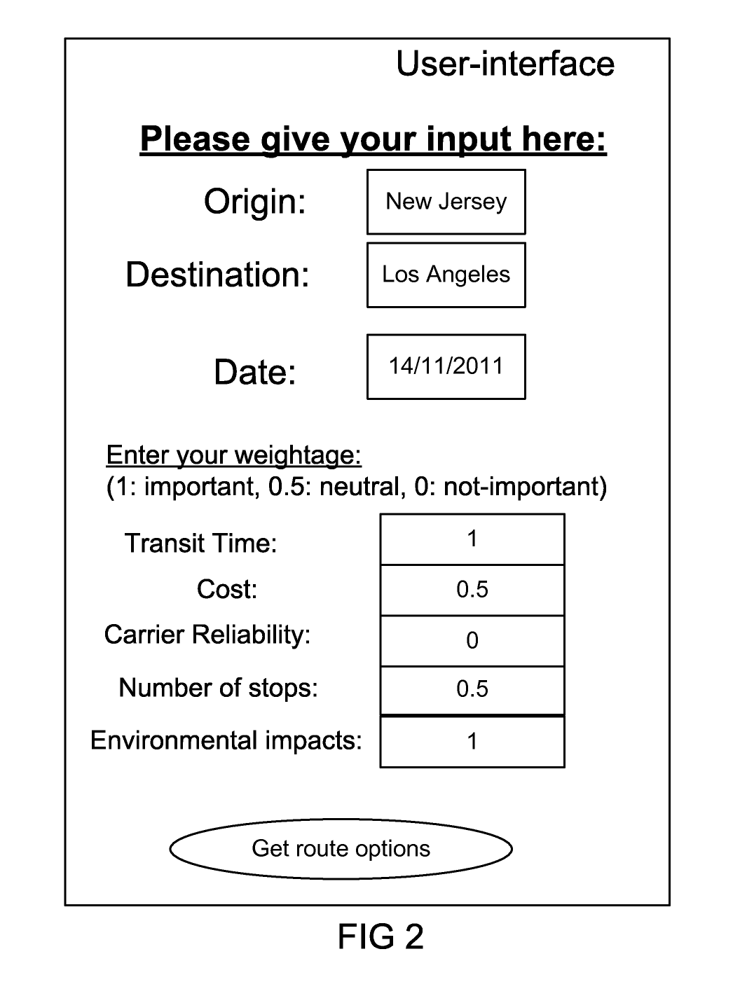

Gathering configuration options: In this setup phase, the system gathers some configuration options from the user, including the lower and upper bounds for all attributes, and the options for aggregate objective function. See FIG. 2 for an embodiment of an interface.

Considering all aspects of an option: As a first step, we expand the number of aspects that can be quantified and compared. Commonly use parameters in a traditional design are transit time and cost. Additionally, we also consider other options, such as the number of intermediate stops, quality of those intermediate stops, carrier reliability, carrier customer satisfaction rating, environmental impact, and the like. Based on the specific situation, any specific aspect that has a quantifiable score attached to it can be included as an aspect of an option. An example list of options with 5 attributes (transit time, cost, stops, environmental impact, and carrier reliability) is shown below. It brings multiple dimensions to the selection process.

TABLE 1
It shows the list of options with multiple attributes
(e.g. the origin is New Jersey, the destination is Los
Angeles, and the departure date is Nov. 14, 2011).

| Op- | | | | | Environmental | Carrier |
|---|---|---|---|---|---|---|
| tion | | Transit | Cost | No. of | Impact (CO2 | reli- |
| No. | carrier | Time | $ | stops | Emission) | ability |
| 01 | AA | 4 hrs | 170 | 0 | 10 | 81 |
| 02 | Delta | 4 hrs 15 min | 165 | 0 | 12 | 90 |
| 03 | United | 4 hrs 30 min | 168 | 0 | 13 | 85 |
| 04 | AA | 5 hrs 30 min | 150 | 1 | 30 | 81 |
| 05 | Jet | 7 hrs 30 min | 120 | 1 | 50 | 75 |
| | Blue | | | | | |
| 06 | Various | 7 hrs 45 min | 110 | 1 | 40 | NA |
| 07 | South | 9 hrs | 90 | 1 | 20 | 60 |
| | West | | | | | |
| 08 | Delta | 12 hrs | 80 | 3 | 60 | 90 |

Multiple Criteria Optimization: Multiple criteria optimization is the process of simultaneously optimizing two or more conflicting objectives subject to certain constraints. Multi criteria optimization problems can be found in various fields: product and process design, finance, aircraft design, the oil and gas industry, automobile design, or wherever optimal decisions need to be taken in the presence of trade-offs between two or more conflicting objectives.

In mathematical terms, the multi criteria problem can generally be written as:

Minₓ[μ₁(x), . . . ,μ₂(x)]^{T}

Such that

g(x)≦0

h(x)=0

x₁≦x≦xᵤ

wherein μᵢ is the i-th objective function, g and h are the inequality and equality constraints, respectively, and x is the vector of optimization or decision variables, with x₁ and xᵤ denoting the limits.

Aggregate objective function: One method for finding a solution to a multi criteria optimization problem is constructing a single aggregate objective function (AOF). The basic idea is to combine all of the objectives into a single objective function, called the AOF, such as weighted linear sum of the objectives. This objective function is optimized, subject to technological constraints specifying how much of one objective must be sacrificed, from any given starting point, in order to gain a certain amount regarding the other objective. One can use a matrix, such as 2×2 matrix, for the presentation.

Linear programming: It is a mathematical method for determining a way to achieve the best outcome (such as maximum profit or lowest cost) in a given mathematical model for some list of requirements represented as linear relationships.

Canonical form: Linear programs problems can be expressed in canonical form, in this general form:

Maximize or Minimize C^{T}x

Subject to: Ax≦b and 0≦x

where x represents the vector of variables (to be determined), c and b are vectors of (known) coefficients, and A is a (known) matrix of coefficients. The expression to be maximized or minimized is called the objective function (C^{T}x in this case). The equations of type (Ax≦b) are the constraints which specify a convex polytope (in N-dimension) over which the objective function is to be optimized.

For example, one may want to choose flights of less than 8 hours, plus price of less than 300 US$.

Standard Form: Standard form is a form of describing a linear programming problem. It consists of the following four parts:
A linear function to be maximized, e.g.:

Max_{x1,x2}f(x₁,x₂)=c₁x₁+c₂x₂
Problem constraints of the following form, e.g.:

a₁₁x₁+a₁₂x₂≦b₁

a₂₁x₁+a₂₂X₂≦b₂

a₃₁x₁+a₃₂x₂≦b₃
Non-negative variables, e.g.:

0≦x₁

0≦x₂
Non-negative right-hand side constants:

0≦bᵢ, for i=1, 2, 3, . . . .

The problem is usually expressed in matrix form, and then becomes:

Max{C^{T}x/(0≦Ax≦b)̂(0≦x)}

Other forms, such as minimization problems, problems with constraints on alternative forms, as well as problems involving negative variables, can always be rewritten into an equivalent problem in the standard form.

The following algorithms can be used: Simplex algorithm of Dantzig, Criss-cross algorithm, Ellipsoid algorithm, Projective algorithm of Karmarkar, or Path-following algorithms.

In the following, we show more aspects of a user planning a trip from New Jersey to Los Angeles. With each aspect having measurable value attached to it, this new representation of routing option would help user to have a broader view on available options.

Removal of Options that do not meet some bounds: In this phase, all options for which some attributes do not meet some bounds are removed. For example, it may be that the passenger does not wish to travel on a flight that has more than 3 intermediate stops, or that the business does not want to use any trucking company that has a total environmental impact greater than a preselected value.

An example algorithm listing that achieves this phase is as follows:

For O in List of Options:

For A in List of Attributes:

if [ (O.A < preselectedLowerBound(A) ) or
( O.A > preselecedUpperBound (A) ) ]

Then: Remove O from List of Options &
proceed to the next option

In route option with different aspects, there is a possibility of conflicting attributes. For example, keeping the cost low, as well as transit time low, with no late departures, requires multiple criteria optimization. Similarly, keeping intermediate stops low or zero and cost low requires multiple criteria optimization.

In one embodiment, we do not use linear programming, because Aggregate Objective Functions can use non-linear equations, as well. In that respect, linear programming (LP) formulation is a special case of Aggregate Objective Functions (AOF). LP formulations can typically be solved faster, but they do not provide adequate flexibility in terms of options.

User Interface Options for Configuring Multi-Criteria Optimization: Tables 2-3 show an example form where user provides information about the origin, destination and date of travel. Also, user specifies its preferences (weightage) for the aspects, such as transit time, cost, carrier reliability, intermediate stops, and the like. User can specify which aspect is important, not-important, or neutral. In the example, user specifies transit time and environmental impact as important, cost and intermediate stops as neutral, and carrier reliability as not-important.

Presenting of Options to the User: Tables 2-3 display the routing option, showing different aspects. The Rank Index column shows the rank of each particular route option, considering user specified options for the aggregate objective function. The user interface lists the options in the descending order of that aggregate objective function. (See Tables 2-3.)

TABLE 2
It shows the list of options (e.g. the origin is New Jersey, the destination is Los Angeles,
and the departure date is Nov. 14, 2011), with the highlighted and selected areas.

| | | | | | Environmental | | |
|---|---|---|---|---|---|---|---|
| Option | | Transit | Cost | No. of | Impact (CO2 | Carrier | Rank |
| No. | carrier | Time | $ | stops | Emission) | reliability | Index |
| 01 | AA | 4 hrs | 170 | 0 | 10 | 81 | 5 ¶ ✓ |
| 02 | Delta | 4 hrs 15 min | 165 | 0 | 12 | 90 | 5.5 ¶ |
| 03 | United | 4 hrs 30 min | 168 | 0 | 13 | 85 | 5.5 ¶ |
| 04 | AA | 5 hrs 30 min | 150 | 1 | 30 | 81 | . . . |
| 05 | Jet Blue | 7 hrs 30 min | 120 | 1 | 50 | 75 | . . . |
| 06 | Various | 7 hrs 45 min | 110 | 1 | 40 | NA | . . . |
| 07 | South West | 9 hrs | 90 | 1 | 20 | 60 | . . . |
| 08 | Delta | 12 hrs | 80 | 3 | 60 | 90 | 13 ¶ |

As shown in Table 2, the first row is check-marked, and the 3^{rd} row is highlighted, as shown in Table 3, below, as the Appendix to Table 2, e.g. Table 3 being overlapped on Table 2, on screen of the computer, for the user interface (GUI), originating from the last (on the right side) column of the 3^{rd} row, from the symbol ¶ shown on the table.

TABLE 3
It shows the pop-up menu or window coming out of Table 2,
overlapping Table 2, on computer screen, as described above,
as an example, for criteria, with weightage and rating:

| Criteria | Weightage | Rating |
|---|---|---|
| Journey Time | 1 | 2 |
| Cost Compare | 0.5 | 4 |
| Intermediate | 0.5 | 1 |
| stops | | |
| Stop delay | 1 | 1 |
| risk | | |
| Carrier | 0 | 2 |
| reliability | | |

Please note that, in one embodiment, we have (for the Table 3, above):

Rank index=Σ(weightage×rating)

The comparison for cost can be done using absolute values or relative values, e.g. the lowest number in the table, as 80 US$, as the baseline. An average number can also be used as the baseline. Then, the ratio of the cost values is multiplied to weight, for comparison purposes, for other possibilities, to find the optimum choice(s).

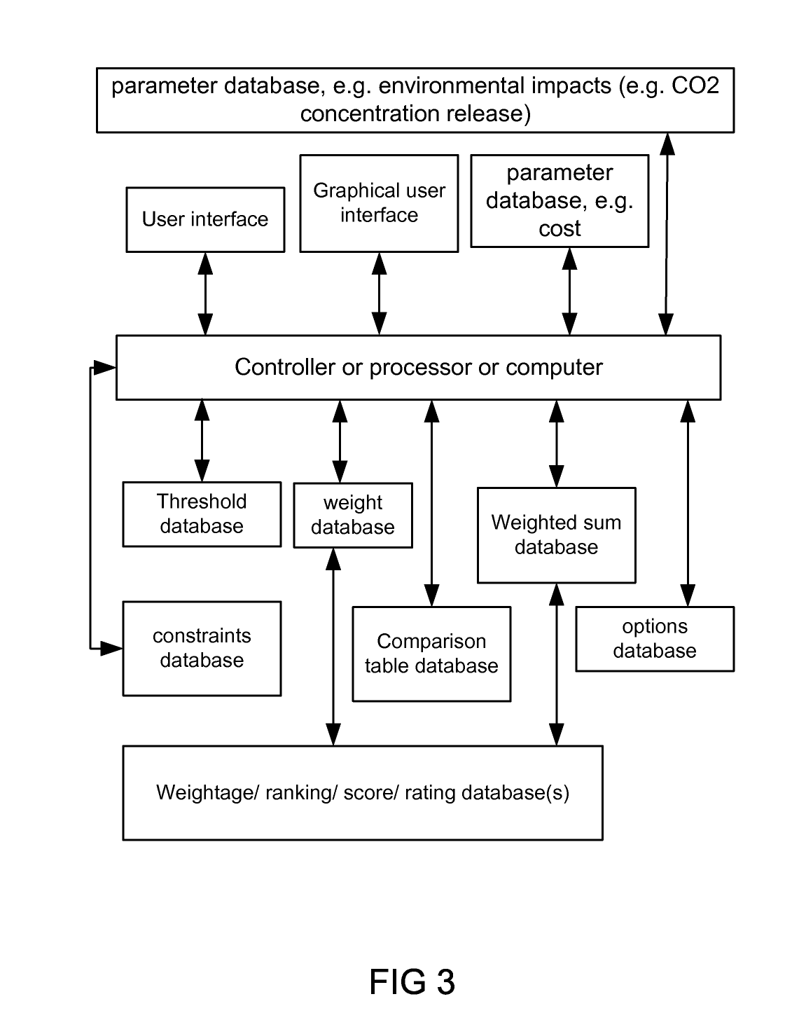

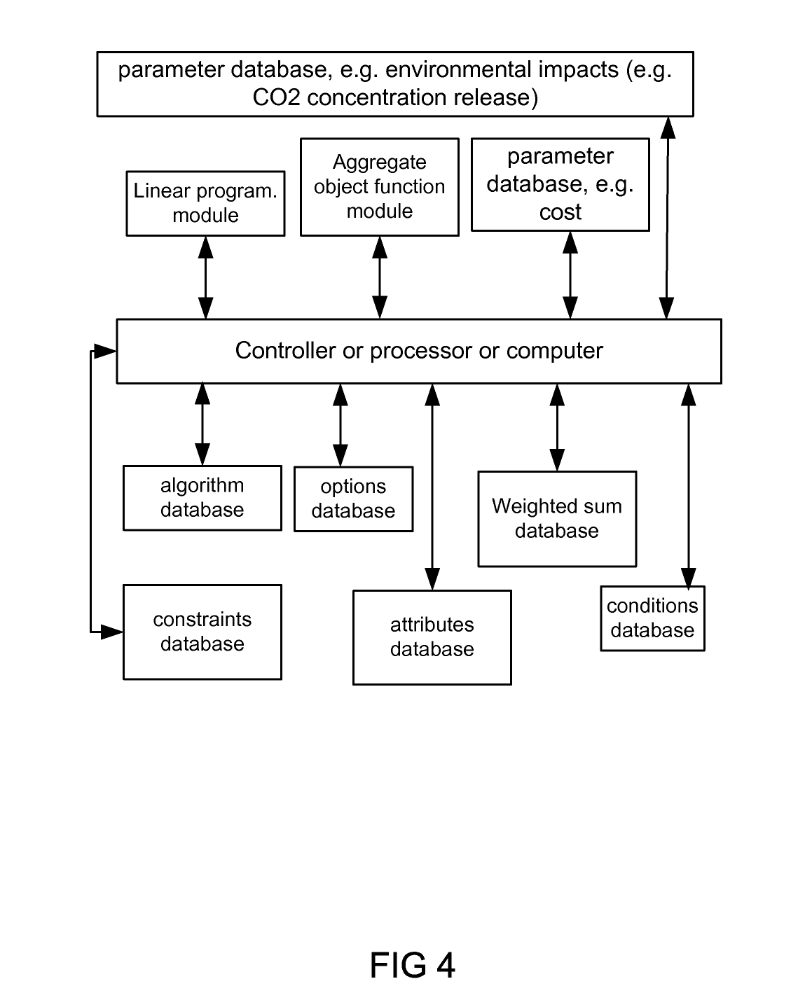

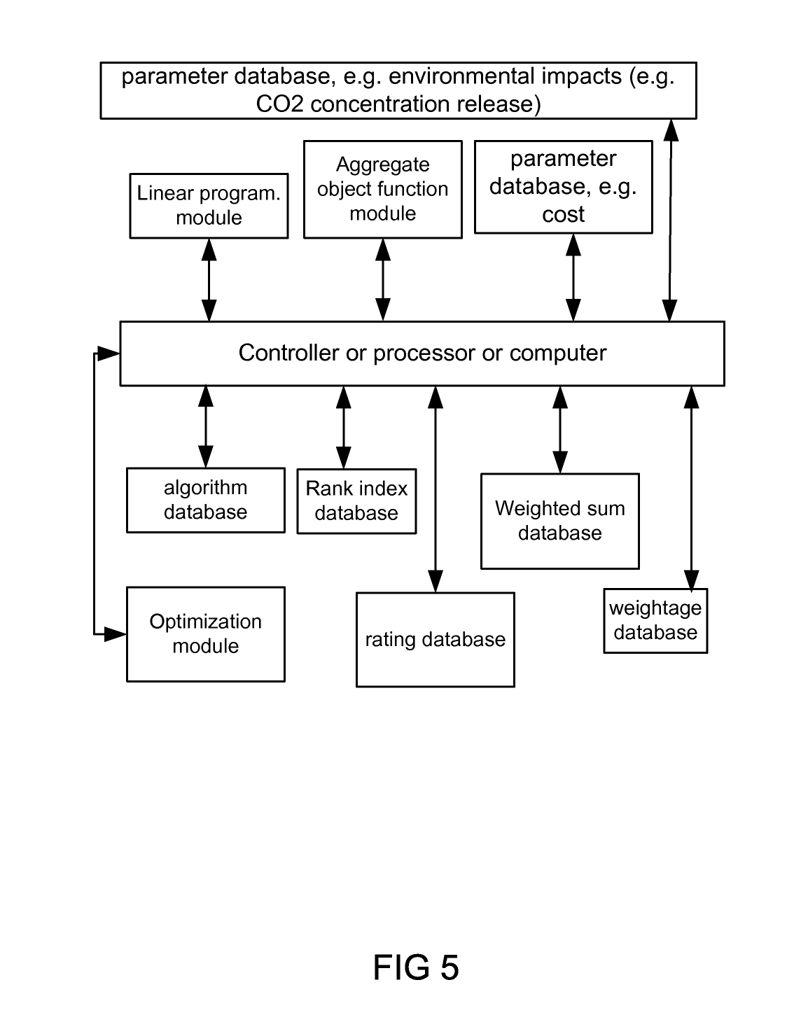

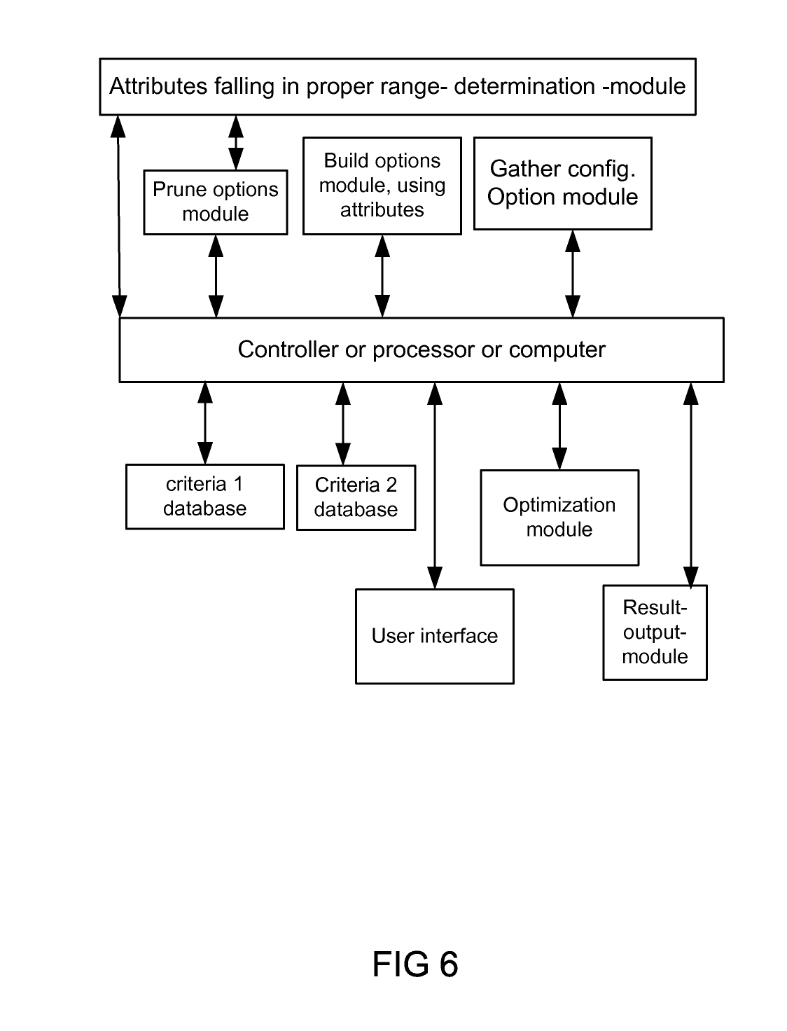

FIG. 3-6 show multiple systems for embodiments of this invention, with various components.

In one embodiment, our system has a central processing unit, along with multiple storage units, with some user input interface/unit, and communication units between processing module and other modules. The data or parameters are stored in memory units, storages, databases, tables, lists, spreadsheets, physical devices or modules or units, or the like. The comparisons and calculations are done by a system, processor, computer, server, computing device, or microprocessor. The modules are connected through buffers or other memory units, with another processor directing all the data transfer and actions, as one embodiment. One can combine processors and memory units, in one or fewer units, if desired, in another embodiment.

In one embodiment, we have a method for calculating and presenting options to a user for planning a trip or transportation, with the following steps: an aggregation module gathering configuration options; a construction module receiving all attributes; the construction module building options, using said all attributes; an evaluator module determining one or more attributes that do not satisfy one or more predetermined conditions; and for those one or more attributes, pruning corresponding options; running multi-criteria optimization; ordering remaining options; and a user interface module presenting options to a user.

In one embodiment, we have one or more of the following the steps for the process: choosing an algorithm, ranking entries, calculating weighted average or weighted sum, applying linear programming, applying aggregate function, applying constraints or conditions, applying thresholds, inequality relationships, or equality relationships, presenting an optimum route for shipping, presenting an optimum route for traveling, classifying weightage as a percentage number, classifying weightage as a real number between 0 and 1, highlighting entries on tables on computer screen, selecting entries on tables on computer screen, displaying popup menus or windows on computer screen, calculating rank index, using weightage and rating values, and normalizing values in a table, using a minimum value, an average value, or a median value.

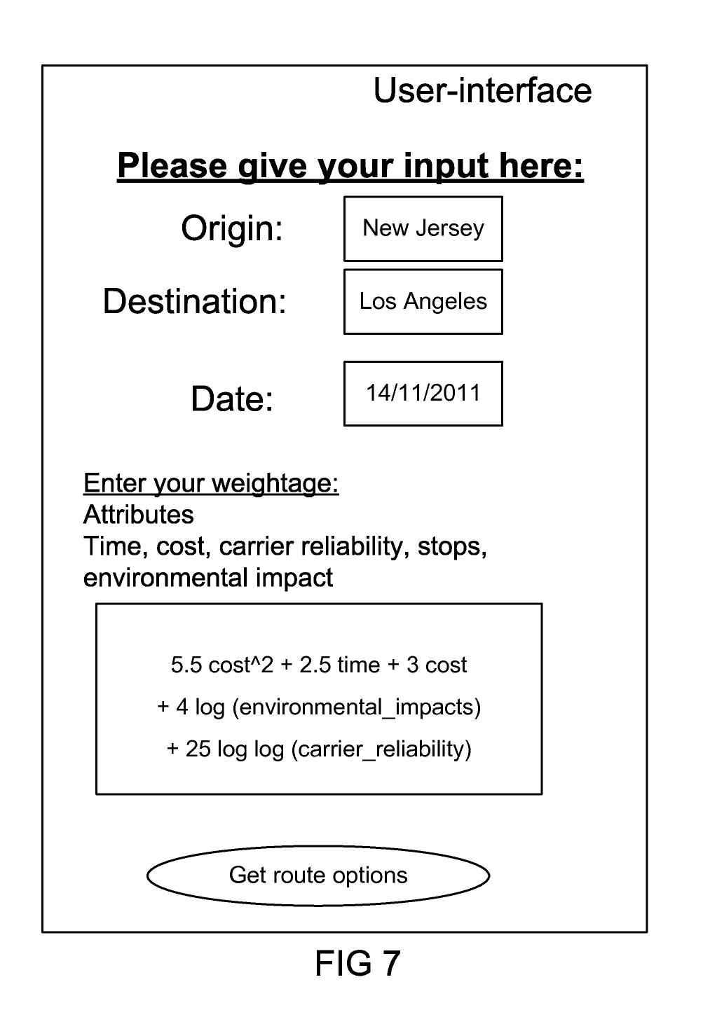

In one embodiment, as shown in FIG. 7, the Aggregate Objective Function (AOF) can be more general than the linear optimization. For example, it can include polynomial terms, logarithmic, and polylog terms. FIG. 7 shows an embodiment of an interface.

Another variation of Table 2 is given below in Table 4, as one embodiment.

TABLE 4
It shows the list of options (e.g. the origin is New Jersey, the destination is Los Angeles,
and the departure date is Nov. 14, 2011), with the highlighted and selected areas.

| | | | | | Environmental | | |
|---|---|---|---|---|---|---|---|
| Option | | Transit | Cost | No. of | Impact (CO2 | Carrier | Rank |
| No. | carrier | Time | $ | stops | Emission) | reliability | Index |
| 01 | AA | 4 hrs | 170 | 0 | 10 | 81 | 5 ¶ ✓ |
| 02 | Delta | 4 hrs 15 min | 165 | 0 | 12 | 90 | 5.5 ¶ |
| 03 | United | 4 hrs 30 min | 168 | 0 | 13 | 85 | 5.5 ¶ |
| 04 | AA | 5 hrs 30 min | 150 | 1 | 30 | . . . | . . . |
| 05 | Jet Blue | 7 hrs 30 min | 120 | 1 | 50 | . . . | . . . |
| 06 | Various | 7 hrs 45 min | 110 | 1 | 40 | NA | 10.5 ¶ |
| 07 | South West | 9 hrs | 90 | 1 | 20 | 60 | 9 ¶ |
| 08 | Delta | 12 hrs | 80 | 3 | 60 | 90 | 13 ¶ |

As shown in Table 4, the first row is check-marked, and the 3^{rd} row is highlighted, with a pop-up menu or window appearing, as the Appendix to Table 4, e.g. Table 4 being overlapped or covered by the pop-up menu or window, on screen of the computer, for the user interface (GUI), originating from the last (on the right side) column of the 3^{rd} row, from the symbol ¶ shown on the table.

The pop-up menu or window shows the phrase (as an example): “Based on Aggregate Objective Function (AOF)”, overlapping Table 4, on the computer screen, as described above, as an example, for any information needed for the user.

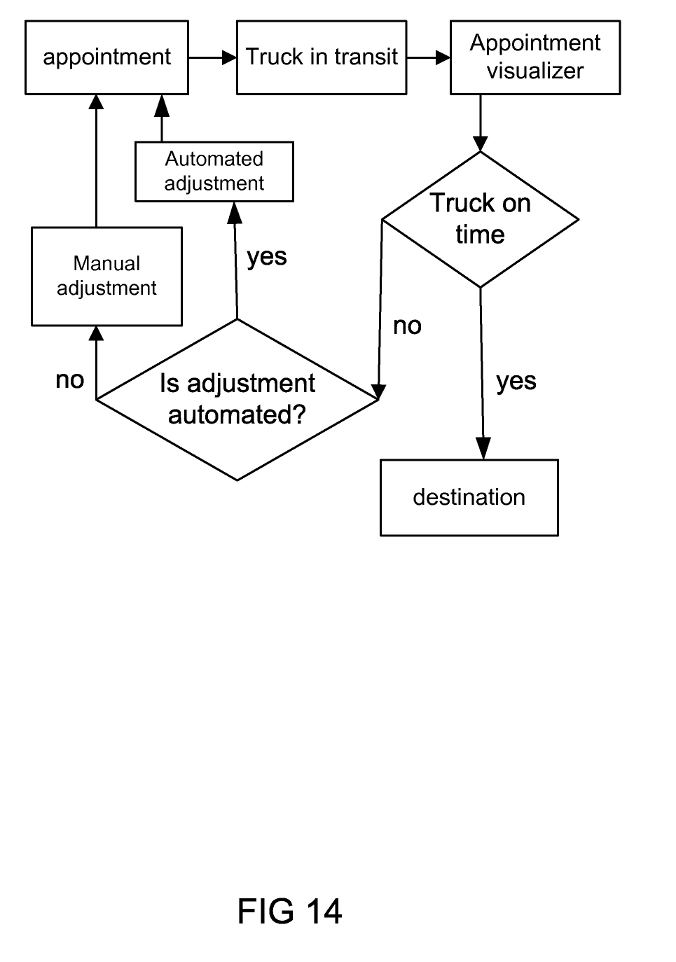

FIG. 14 shows a flow chart of a method of an embodiment of the invention. The decisions are made for “Truck is on time?” and “Is adjustment automated?” for the flow chart, with options shown as “automated adjustment” and “manual adjustment”, which is followed by “appointment” and “truck in transit” boxes/steps, which ends up with “appointment visualize”, which goes back to “Truck is on time?” stage or step, again, as a loop, which can end up as “Destination” for positive/“Yes” result (for the decision/evaluation box/step), as shown in FIG. 14.

Any variations of the above teaching are also intended to be covered by this patent application.

1. A method for presenting entries for schedules for transportation to a user, said method comprising:
first input module receiving trucking data;
second input module receiving terminal or port data;
a processor calculating estimated time of arrival;
third input module receiving global positioning system signal, radio frequency identification signal, or phone call data;
updating said estimated time of arrival using said global positioning system signal, radio frequency identification signal, or phone call data;
a graphical user interface mapping a first truck with said updated estimated time of arrival;
said graphical user interface prompting said user to filter entries according to terminal location and appointment date;
said graphical user interface summarizing truck arrivals;
said processor receiving one or more rules from a policy module;
adjusting said truck arrivals based on said one or more rules;
displaying said adjusted truck arrivals.

2. The method for presenting entries for schedules for transportation to a user as recited in claim 1, wherein said one or more rules are based on number of changes.

3. The method for presenting entries for schedules for transportation to a user as recited in claim 1, wherein said one or more rules are based on changes.

4. The method for presenting entries for schedules for transportation to a user as recited in claim 1, wherein said one or more rules are based on waiting time.

5. The method for presenting entries for schedules for transportation to a user as recited in claim 1, wherein said one or more rules are based on cost.

6. The method for presenting entries for schedules for transportation to a user as recited in claim 1, wherein said one or more rules are based on order backlog.

7. The method for presenting entries for schedules for transportation to a user as recited in claim 1, wherein said one or more rules are based on total mileage.

8. The method for presenting entries for schedules for transportation to a user as recited in claim 1, wherein said one or more rules are based on gas expense.

9. The method for presenting entries for schedules for transportation to a user as recited in claim 1, wherein said one or more rules are based on inventory.

10. The method for presenting entries for schedules for transportation to a user as recited in claim 1, wherein said one or more rules are based on truck traffic.

11. The method for presenting entries for schedules for transportation to a user as recited in claim 1, said method comprising: distinguishing and classifying late arrivals.

12. The method for presenting entries for schedules for transportation to a user as recited in claim 1, said method comprising: distinguishing and classifying early arrivals.

13. The method for presenting entries for schedules for transportation to a user as recited in claim 1, said method comprising: distinguishing and classifying on-time arrivals.

14. The method for presenting entries for schedules for transportation to a user as recited in claim 1, wherein said one or more rules are static.

15. The method for presenting entries for schedules for transportation to a user as recited in claim 1, wherein said one or more rules are dynamic.

16. The method for presenting entries for schedules for transportation to a user as recited in claim 1, wherein said one or more rules are changed by said user.

17. The method for presenting entries for schedules for transportation to a user as recited in claim 1, wherein said one or more rules are changed by an administrator.

18. The method for presenting entries for schedules for transportation to a user as recited in claim 1, wherein said one or more rules are changed by said processor.

19. The method for presenting entries for schedules for transportation to a user as recited in claim 1, wherein said one or more rules are based on said trucking data;

20. The method for presenting entries for schedules for transportation to a user as recited in claim 1, wherein said one or more rules are based on said terminal or port data.
